(19) United States
(12) Patent Application Publication
(10) Pub. No.: US 2016/0086018 A1
(43) Pub. Date: Mar. 24, 2016

(54) FACIAL RECOGNITION METHOD AND APPARATUS

(71) Applicant: WEST VIRGINIA HIGH TECHNOLOGY CONSORTIUM FOUNDATION, INC., Fairmont, WV (US)

(72) Inventor: Brian E. Lemoff, Morgantown, WV (US)

(73) Assignee: WEST VIRGINIA HIGH TECHNOLOGY CONSORTIUM FOUNDATION, INC., Fairmont, WV (US)

(21) Appl. No.: 14/787,212

(22) PCT Filed: Apr. 25, 2014
(86) PCT No.: PCT/US2014/035426

§ 371 Date: Oct. 26, 2015

Related U.S. Application Data
(60) Provisional application No. 61/816,451, filed on Apr. 26, 2013.

(51) Int. Cl. G06K 9/00; H04N 5/232; H04N 5/225; H04N 5/33

(52) U.S. Cl. CPC G06K 9/00288; H04N 5/33; H04N 5/23219; G06K 9/00255; H04N 5/2256

(57) ABSTRACT

An active-imaging system useful for biometric facial recognition has an optical head with a short-wave infrared (SWIR) imager, an illuminator, and a processor. The imager and illuminator are aligned and mounted on a single pan-tilt stage. The illuminator produces a wavelength of light greater than 1400 nm and less than 1700 nm, which is centered on the imager field of view. An electronics box having power supplies, communications electronics, and a light source for the illuminator can be included. The electronics box is connected to the optical head by an umbilical having cables to deliver light and power to support data communication to and from the optical head. The processor is connected to the electronics box for comparing SWIR-illuminated facial images captured by the imager to a database of visible-spectrum face images.

### CROSS REFERENCE TO RELATED APPLICATIONS

This application claims the benefit of U.S. provisional patent application No. 61/816,451, which was filed Apr. 26, 2013.

### GOVERNMENT LICENSE RIGHTS

This invention was made with government support under contract N00014-09-C-0064 awarded by the Office of Naval Research. The government has certain rights in the invention.

### FIELD OF INVENTION

This application relates to biometrics, and, more specifically, to an apparatus and method for day or night extended-range biometric facial recognition.

### BACKGROUND

The capability to detect and identify people from a great distance, night or day, without their knowledge, could have many applications for defense, law enforcement, and private security. Under daylight or otherwise well-lit conditions, it is possible today for an operator using high-power optics to manually identify a person at a distance if the person to be identified is familiar to the operator or if the operator can refer to a short watch list of mug shots. Automated identification at long range is not yet available.

Biometric technologies commonly used to identify people include: fingerprint, iris, DNA, and face recognition. Of these, the only one that potentially can be used for long-range standoff identification is face recognition. Other modalities that have been used to classify, but not identify people, are called soft biometrics. These include height, weight, gait, and facial hair, among others.

There presently are many vendors of face recognition software. However, these software packages are all optimized for matching frontal-pose high-resolution visible-spectrum facial images against other frontal-pose high-resolution visible-spectrum facial images. As the pose angle increases and the image resolution decreases, the facial recognition performance degrades.

At night, or under otherwise dark or poorly-lit conditions, there currently is no technology that produces imagery of sufficient resolution or quality that allows for long-range identification, either manual or automated. There is a need in the industry for an extended range day or night imaging system that safely and automatically identifies a person without his or her knowledge.

Covert, long-range, night/day human identification requires the integration of several capabilities. First, a person must be detected and his or her location determined. Then, as people rarely stand still long enough to be identified, the person must be tracked as he or she moves. Close up facial imagery must then be captured with sufficient resolution and quality to make a positive identification. This typically requires a minimum of 20 pixels between the eyes, or a resolution of roughly 3 mm per pixel, although resolution better than 1 mm per pixel is often stated as a requirement for high-performance computer face recognition. For the capability to work night and day, the imaging technology must be able to work under conditions ranging from bright sunlight to total darkness.

There are a number of long-range imaging technologies commercially available today for human surveillance applications. However, none is viable for long-range, covert, night/day human identification. Whether the goal is computer face recognition or simply recognition by a human operator, visible-spectrum imagery will always produce the best result if conditions allow for a quality image to be obtained. Unfortunately, under nighttime or otherwise dark conditions, there is insufficient ambient illumination of the target to produce a visible image. A spotlight could be used, but this would not be covert, and the intensity required to produce a high-quality close-up facial image at long range would be damaging to the eye.

Thermal or long-wave infrared (LWIR) imagery can be used for nighttime detection of people, but it does not produce recognizable facial imagery necessary for biometric facial recognition. In addition, thermal imagers are better suited to wide-angle imagery, as narrow-angle thermal imagery, e.g., 2 mm per pixel at 150 m range, requires very large and heavy lenses. LWIR imagery reveals the thermal profile of a person's face, rather than skin surface texture and features, precluding LWIR images from being correlated with or matched to visible-spectrum facial imagery. Also, the LWIR appearance of a person's face will change depending upon the thermal conditions and the person's metabolic state. This variability, along with the poor correlation between thermal facial images and visible-spectrum facial imagery, prevents thermal infrared imagery from being viable for use to identify people based on a watch list of visible-spectrum facial images, such as mug shots.

Passive SWIR imagery is another technology that can be used for day/night wide-area surveillance. Ambient “night-glow” provides sufficient illumination for wide-angle imagery using passive SWIR, but narrow-angle imagery, which is necessary to capture a facial image for biometric facial recognition, is not possible with passive SWIR.

Active near-Infrared (NIR) surveillance systems also are available and, when combined with a long-range camera having a NIR illuminator (around 800 nm), can produce high-quality, long-range imagery night and day. By illuminating the camera field of view with light that is invisible to the human eye, but close-enough to the visible spectrum to produce familiar-looking imagery, high-quality long-range imagery is possible. However, useful image signal levels can only be achieved using NIR at long range by creating a severe eye-safety hazard in close proximity to the illuminator. NIR illumination also is seen easily with night vision goggles and most silicon-based cameras, and thus cannot be used covertly.

There remains a need in the industry for an apparatus, preferably sufficiently compact to be portable, that has the ability to identify covertly a person at long-range under varying light conditions, e.g., well-lit or dark, without creating an eye-safety hazard for the operator of the system or the person being identified.

### SUMMARY

The present invention solves the foregoing problems by providing a portable apparatus that can covertly detect, track, and capture a biometrically recognizable facial image of a person to be identified at long-range, day or night. The hardware of the apparatus can be scaled for different applications, e.g., stationary constant surveillance and identification, or special operations field use by an individual or small team. A handheld portable apparatus for field use by special operations personnel also can include different software functionality as dictated by the intended use. Regardless of the size of the hardware and the functional software, the resulting image generated by the apparatus of the present invention has sufficient quality that it can be compared, either manually or automatically using biometric facial recognition software, to a database of visible spectrum images for a match and identification. Repeatable, recognizable images of people under both daytime and nighttime conditions, at distances well beyond 100 m, can be captured and matched to a visible-spectrum database using computer face recognition software. High-confidence matching can be accomplished through the fusion of matching results from many video frames, acquired as a single person is tracked over time.

Active-SWIR imagery at wavelengths >1400 nm, and preferably near 1550 nm, overcomes the limitations of active-NIR imagery because SWIR-illumination is completely invisible to night-vision goggles (NVG) and humans, and the eye-safe power levels are much higher. Table 1 shows a comparison of the visibility and maximum eye-safe power levels of different illumination wavelengths.

As defined in the ANSI Z136 and IEC 60825 laser eye safety standards, Class 1M means that there is no hazard to the naked eye, but there is a potential hazard when magnifying optics, e.g., binoculars or scopes, are used, while Class 1 means that there is no hazard, even when magnifying optics up to 7× are used. For the present application, the minimum illumination spot diameter intentionally shined on the face of a person to be identified is 1 meter, and Class 1 safety at that diameter is accomplished. The output aperture of the illuminator is limited to 5 inches. The safe power level at 1550 nm is approximately 65 times higher than at 800 nm.

TABLE 1
Comparison of potential illumination wavelengths.

| | Human | NVG | Class 1 @ 1 m | Class 1M @ 5- |
|---|---|---|---|---|
| Wavelength | visibility | visibility | diameter spot | inch diameter |
| 800 nm | Dull red glow | Visible | <0.248 W | <0.203 W |
| 980 nm | Invisible | Visible | <0.568 W | <0.467 W |
| 1064 nm | Invisible | Visible | <0.780 W | <0.642 W |
| >1400 nm | Invisible | Invisible | <16.7 W | <13.17 W |

The present invention also solves the foregoing problems in the industry by providing a portable active-SWIR imaging system that is capable of generating recognizable facial imagery at distances of up to at least 350 meters under conditions ranging from bright sunlight to total darkness.

A first aspect of the invention is an active-imaging system including an optical head having (i) a short-wave infrared (SWIR) imager with a field of view and (ii) an illuminator, wherein the imager and illuminator are aligned and mounted on a single pan-tilt stage such that the illuminator produces a beam of light always centered on the imager field of view, and further wherein the illuminator uses a wavelength of light greater than 1400 nm and less than 1700 nm; an electronics box comprising power supplies, communications electronics, and a light source for the illuminator, wherein the electronics box is connected to the optical head by an umbilical comprising cables to deliver light and power to support data communication to and from the optical head; and a processor connected to the electronics box for comparing facial images captured by the imager to a database of visible-spectrum face images.

A second aspect of the invention is an apparatus including an active-imaging system for capturing facial images illuminated with short-wave infrared light having a wavelength greater than 1400 nm and less than 1700 nm; and a processor in communication with the active-imaging system, wherein the processor compares facial images captured by the active-imaging system to a database of visible-spectrum face images to locate a match and identify a person.

A third aspect of the invention is a method of identifying a person using biometric facial recognition, including illuminating the person's face with SWIR, wherein the SWIR is between 1400 nm and 1700 nm; capturing an image of the person's face while illuminated with SWIR; and comparing the captured facial image to a database of visible-spectrum facial images to locate a match and identify a person.

A fourth aspect of the invention is a method of identifying a person using biometric facial recognition, including detecting the presence of the person to be identified; illuminating the person's face with short-wave infrared (SWIR) light having a wavelength greater than 1400 nm and less than 1700 nm; capturing an image of the person's face while illuminated with the SWIR light; and matching the captured image to a database of visible spectrum images.

### BRIEF DESCRIPTION OF THE DRAWINGS

The present invention is described with reference to the accompanying drawings. In the drawings, like reference numbers indicate identical or functionally similar elements. The left-most digit(s) of a reference number identifies the drawing in which the reference number first appears.

FIG. 1 is a perspective view of the optical head, electronics box, and processor of one of many embodiments of the invention.

FIG. 2 is a schematic representation of the optical head, electronics box, and processor of one of many embodiments of the invention.

FIG. 3 is a plan view of an optical head interior, ray-trace of the zoom imaging optics showing the widest angle (upper) and narrowest angle (lower) configurations, and ray-trace of the zoom illuminator showing the narrowest divergence configuration.

FIG. 4 shows a compact embodiment of the optical head juxtaposed to scale against a larger optical head that may be used for stationary or less mobile applications.

FIG. 5 shows the receiver operating characteristic generated using a commercial biometric facial recognition software product using SWIR-illuminated images of 56 test subjects at 50 m and 106 m range in total darkness. A correct acceptance rate of roughly 70% was achieved with false acceptance rate of 1% at both distances.

### DETAILED DESCRIPTION

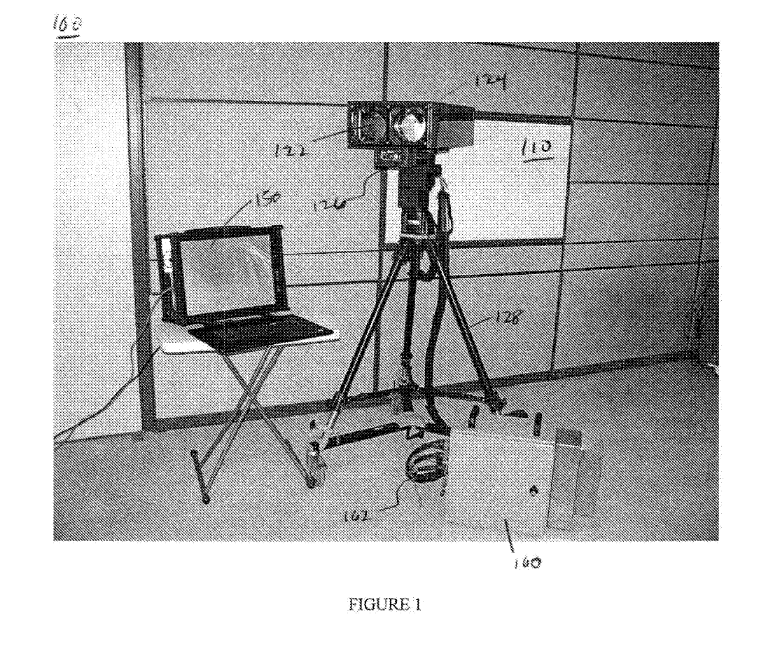

Referring generally to the figures, and more specifically to FIG. 1, there is shown one of many preferred embodiments of an apparatus 100 of the present invention. Among other elements and features as discussed herein, the apparatus 100 includes an active-imaging system 110 for capturing facial images illuminated using short-wave infrared (“SWIR”) light having a wavelength of greater than about 1400 nm and less than about 1700 nm, and a processor 150 in communication with the active-imaging system 110. The processor 150 can compare facial images captured by the active-imaging system 110 to a database of visible-spectrum face images to locate a match and identify a person. The active-imaging system 110 also can include a laser range finder for measuring distances to objects or people to be illuminated and imaged. For purposes of this application, the facial images captured using the active-imaging system 110 shall be referred to as “SWIR-images” or “SWIR-illuminated images.”

The processor 150 can be connected to an electronics box 160 by an Ethernet cable or switched network. Ethernet cables as long as 300 feet can be used. The processor 150 can run software that functions to, among other things, provide low-level hardware control, automation, enterprise messaging, face recognition, and operation of the graphical user interface (“GUI”). Low-level hardware control software moves the lenses in the imager 122 and illuminator 124 to achieve the correct zoom and focus, controls the pan-tilt stage 126, controls the image sensor and receives video, and controls other system components such as the light source, GPS, laser rangefinder, and temperature controllers. Automation software can detect people and faces in the live video, and can automatically track moving targets and automatically queue detected faces for face recognition. Messaging software allows the apparatus 100 to interoperate with other systems that may need access to the apparatus 100 status, target position, target identity, or may need to cue the active-imaging system 110 to point to a particular location. The GUI allows an operator to view live video while controlling and monitoring all of the apparatus 100 software functions.

The electronics box 160 can be connected to the optical head 120 by an umbilical 162. The umbilical 162 can include power, data communications, and optical cables.

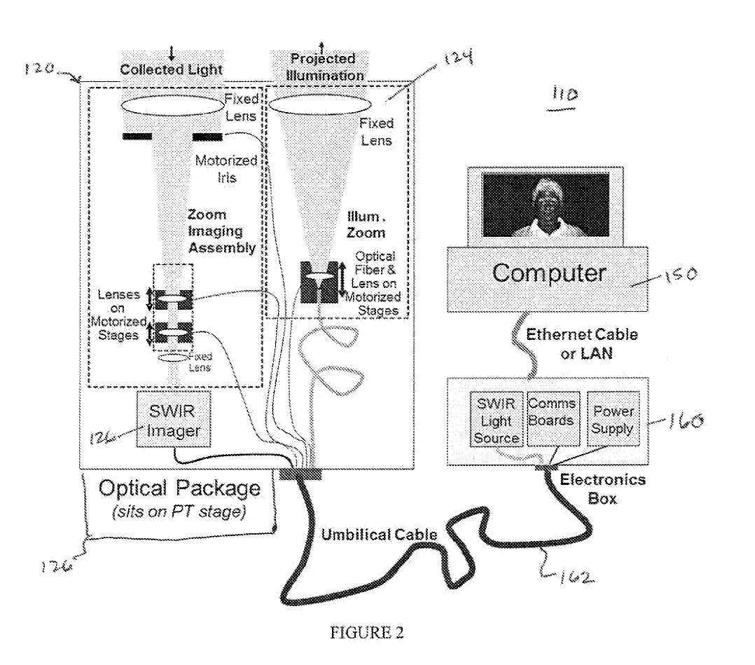

As shown more clearly in FIG. 2, the active-imaging system (“system”) 110 optionally but preferably includes an optical head 120. The optical head 120 can be positioned on a pan-tilt (PT) stage 126 and can include an illuminator 124 and an imager 122. The illuminator 124 preferably uses a wavelength of between about 1500 nm and 1600 nm. The imager 122 and illuminator 124 can be aligned and mounted on the pan-tilt stage 126 such that the illuminator 124 produces a beam of light always centered on the imager 122 field of view. The optical head 120 with PT stage 126 can be mounted on a tripod 128 or other mounting system as needed.

The illuminator 124 and imager 122 can be combined into a single optical head 120. The imager 122 and illuminator 24 preferably can pan, tilt, and zoom together so that the illuminator 124 beam is always just filling the imager 122 field of view. This serves to maximize the image signal level and avoid wasted light. The imager 122 and illuminator 124 can each have a 53× total zoom ratio (the imager has 10× optical, 5.3× digital, while the illuminator has 53× optical zoom). The illuminator 124 light source can be located in the electronics box 160 and deliver a maximum power of 5 W to the optical head 120 through an optical fiber in the umbilical 162. The light source can include a fiber-coupled superluminescent LED with wavelength centered at 1550-nm, filtered by a band-pass filter with a 5-nm full width at half maximum, and amplified by an Erbium-doped fiber amplifier. An LED optionally but preferably is used instead of a laser to provide broader-band, lower-coherence illumination, reducing the effects of laser speckle.

The zoom optics in the imager 122 can be optimized for monochromatic imaging of a narrow field of view, allowing a dramatic reduction in lens complexity and weight relative to traditional zoom optics that must compensate for chromatic aberration and provide distortion-free images over the entire zoom range. A preferred image sensor can use Indium Gallium Arsenide (InGaAs) focal plane array (FPA) technology. Vendors of this technology include Sensors Unlimited, Inc (SUI), now part of United Technologies, FLIR, and Xenics. Available formats include 320×256, 640×512, and 1280×1024 pixels. Of these, the SU640HSX offers the highest sensitivity, and is the preferred sensor.

An electronics box 160 can be connected to the active-imaging system 110 for providing power, light through an optical fiber, and communications to the optical head 120.

The processor 150 can be used for detecting a person to be identified, and tracking the person until identification is possible. The processor 150 can be a specially programmed general purpose computer for operating the user interface, providing low-level optical head 120 control functions and system automation, and running face recognition software.

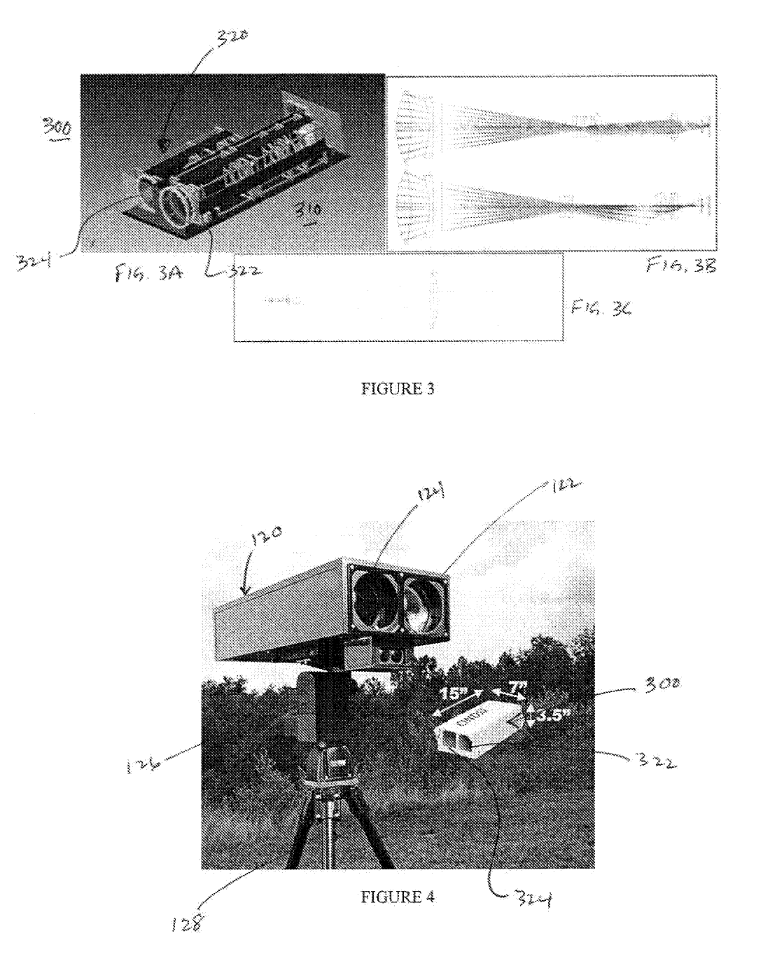

FIG. 3 shows an alternative of an apparatus 300 of the invention, which is a compact, man-packable, active short-wave infrared (SWIR) imaging system 310 that can be used to monitor human activity, automatically detect and track dismounted personnel, recognize familiar individuals, and identify personnel from a watch list using computer face recognition, night or day, at long range. The apparatus 300 also can be used to detect optics such as rifle scopes and binoculars. The apparatus 300 scales hardware designs to smaller size, weight, and power, adding modularity to both hardware and software, and builds on existing software algorithms to improve performance, and to add the functionality needed to address the needs of special forces, among others.

The apparatus 300 can include an optical head 320 that preferably weighs between 5 and 10 lbs, a precision pan-tilt stage that weighs about 5 lbs, a tripod or other mounting system, and an electronics box, that weighs between about 25 and about 50 lbs. One or more computer modules is included to operate the system 310. The optical head 320 of the apparatus 300 preferably is an environmental enclosure that includes the imager 322, illuminator 324, laser rangefinder, communications and electronic components, and a thermoelectric cooler/heater. In one of many possible embodiments, the head measures approximately 15″×7″×3.5″ and weighs between 5 lbs and 10 lbs.

FIG. 3(b) shows an example of the imager 322 in the “zoomed in” and “zoomed out” configurations. The imager 322 can have about a 2.5-inch input aperture and a 10× optical zoom, with focal length varying from 188 mm to 1880 mm (corresponding to a field of view at 75-m range varying from 0.64 m to 6.4 m). The imager 322 can include 4 lens doublets, the first and fourth being fixed, and the second and third movable by small stepper motors. A motorized iris diaphragm can be located after the first doublet. The image is detected by a 640×512-pixel SU640HSX focal plane array (FPA). A narrow optical band-pass filter is placed in front of the FPA to pass only light near the 1550-nm illumination wavelength, rejecting all other ambient light.

FIG. 3(c) shows an example of the illumination optics of the apparatus 300. A single-mode optical fiber can deliver the 1550-nm light from an optical source, located in the electronics box, to the optical head 320. The illumination optics can include 3 lenses: a small lens near the optical fiber that transforms the fiber's Gaussian output beam to a uniform circular disk, a second lens to expand the beam to fill the 2.5-inch output aperture, and the 2.5-inch output lens that collimates the illumination beam to its final divergence angle. Two small motors can move the first two lenses and optical fiber, allowing the output beam divergence to vary from 5.7° to 0.14°; projecting a uniform 1-m diameter spot at a distance ranging from 10 m to 400 m, while always maintaining a beam diameter of 2.5-inches at the exit of the illuminator 324. The illuminator 324 divergence is automatically synchronized to the optical and digital zoom settings of the imager 322, so that only the displayed image field of view is illuminated making most efficient use of illuminator 324 power to maximize the image signal level. The 1550-nm optical source optionally but preferably is an Erbium-doped fiber amplifier (EDFA), seeded by a filtered light-emitting-diode (LED) with an optical line width of roughly 5 nm. The maximum illuminator 324 power is 2.5 W, guaranteeing Class 1M eye safety at point-blank range.

FIG. 4 shows the optical head 320 of the apparatus 300 juxtaposed to scale against an optical head 120 of the apparatus 100, which may be used for stationary use. In addition to producing clear night/day human surveillance and recognizable human facial imagery, the optical design of the apparatus 300 allows for the easy detection of optical devices such as cameras, binoculars, and rifle scopes under nighttime, overcast, and other low-light conditions. Because optical devices retro-reflect the apparatus 300 illuminator back into the apparatus 300 imager 322, the optical devices produce a very large return signal through “optical augmentation” (OA). When the imager is set to high gain, as it is under low-light conditions, the result is a large, easy-to-detect saturated spot in the image.

In addition to the imager 322 and illuminator 324, the apparatus 300 optical head 320 can include a laser rangefinder (LRF). The LRF can be aligned to the center of the imager 322 field of view, providing an accurate range for detected human targets. The preferred LRF model is an Instro LRF100, which weighs about 100 g with a typical range of 2.5 km. The LRF can use a 1550-nm laser that blinks visibly in the apparatus 300, allowing an operator to confirm that the LRF is actually hitting the desired target.

The optical head 320 can be mounted to a precision pan-tilt (PT) stage. The preferred stage is a FLIR PTU-D47, with a weight of about 5 lbs. and a precision of 0.003°, equivalent to 2 cm of target translation at a range of 400 m. Using an onboard GPS, LRF and a simple calibration procedure, the apparatus 300 can be calibrated to display the geographical coordinates, including elevation, of the currently imaged target and can quickly slew to any specified coordinates. With the PT stage, the apparatus 300 has a field-of-regard of 318° and can slew to any bearing within that range as well as track a target as it moves within the apparatus 300 field of regard. The optical head with PT stage can be mounted on a tripod or other mounting system as needed.

To minimize weight and power dissipation of the optical head, a separate electronics box can house the optical source, the power supplies for all of the motors, sensors, and electronics in the optical head, and the communication electronics required to interface with local and/or remote computers. An umbilical can connect the electronics box to the optical head and will include power, data, and optical connections. The size and weight of this box can vary depending on the required level of cooling and the desired level of ruggedness. A modular cooling design may be used that would allow the user to bring more or less cooling hardware, depending on mission requirements. For example, if the system will only be operated at night, it would need much less cooling than if it were to be operated on a sunny desert day in direct sunlight. The weight of the electronics box preferably is in the range of about 25 to about 50 lbs. The apparatus 300 can operate on BB-2590 batteries.

The specific computer hardware utilized in the apparatus 300 can vary depending on the specific needs of the operation in which the apparatus 300 is being used. Software functions can include camera control, GUI, automation, interoperability, and face recognition. For a manned operation, all functionality can be implemented on a single, powerful computer, such as a high-end laptop or a VPX-1256 mini-computer from Curtiss-Wright (Intel Core i7 Quad-core, 60W power). Alternatively, for unattended operation, functions like the low-level camera control and the automation, along with remote communications could be implemented locally using Gumstix computers, while the GUI, face recognition, and interoperability functions can be implemented on a remote computer that could be shared with other applications and sensor systems. Some of the functions, such as the camera control and autonomous tracking, require little computing power but do require very low communication latency, so implementing these locally on Gumstix (extremely small computer-on-module) or equivalent is preferred. The face recognition software requires more computing power, but is completely insensitive to latency, so this lends itself well to running remotely.

In operation, the first step in using the apparatuses 100 or 300 to identify a person is to detect the person's presence. For purposes of describing the operation of the invention, the embodiment of the apparatus 100 will be referred to for convenience, but the process applies equally to the embodiment of the apparatus shown at 300. To detect a person to be identified, the optical head 120 is pointed in the general direction of a potential target. Once the apparatus 100 is set up and calibrated, the optical head 120 can point and focus, either manually or automatically using the processor 150, on any specified geographical coordinates within its range. Alternatively, a wide angle sensor, such as a ground moving target indicator (GMTI) radar system or wide-angle camera, e.g., visible spectrum, SWIR, or thermal IR, can be used in conjunction with the apparatus 100 to provide initial detection of personnel within range of the apparatus 100. Target coordinates for a detected person can then be input into the processor 150 to provide initial cuing of the system 110. An operator also can use the system 110 to scan across areas of interest or let the system 110 dwell at specific locations of concern, such as at roads or walkways leading up to a facility to be protected.

Common approaches to automatically detect a person in surveillance video can include change detection, motion detection, and cascade pattern recognition. Change detection works well for fixed surveillance cameras where a static background image can be captured and compared to a live image. For a pan-tilt-zoom system such as the apparatus 100, this is not a viable approach. Motion detection is a good way to rapidly detect moving objects in video, but it cannot distinguish between a person and any other moving object. Cascade pattern recognition searches images for patterns that match a set of training images. This approach can be as specific as the training dataset, but the approach can also be time consuming depending upon the complexity of the pattern and the range of search parameters. For purposes of using the apparatus 100, motion detection and cascade approaches can be combined by using motion detection to narrow the range of possible target locations in an image prior to starting a cascade search.

A cascade can be used to detect personnel in system 110 imagery. Because feet and legs are often obscured by terrain and vegetation, an algorithm can be used to detect people from the waist up. People have been detected both during the day and at night as far away as 3 km using the apparatus 100 and an exemplary cascade algorithm. The speed of cascade pattern detection depends upon the size of the search area and the range of sizes of the pattern to be detected. The apparatus 100 can increase the speed of personnel detection by using the known field of view to narrow the range of person sizes to search for.

When used in an installation protection application, the apparatus 100 can initially detect personnel while in its widest-angle zoom setting. Once detected, an operator or the processor 150 can select the target for tracking. At this point, a detection box from the upper-body detection can be sent to a tracking algorithm in the processor 150 that controls the pan-tilt stage 126 to keep the selected person centered in the imager 122 field of view. If the detected person is beyond the 400-m upper limit for face recognition, tracking will continue at the widest zoom setting. Once the person comes within face recognition range (<400 m), the system 110 will zoom in on the head while continuing to track his or her movement and centering the person's head in the imager 122 field of view. Heads at different angles can be detected, for example side profiles and the back of the head, in order to continue to track a person's head at the highest zoom setting. Facial features do not need to be clearly visible for the system 110 to be able to continue tracking a person. The speed of the face/head detection can be dramatically increased by narrowing the search area to only the upper portion of the tracking box and narrowing the size range to a typical head size given the known field of view.

Tracking can be controlled manually or automatically. For automatic tracking, the system 110 will detect any movement and decide whether it is human activity. If the movement is made by a person to be identified, the system 110 would then zoom in on the head and check for a high quality face for recognition. If a sufficiently high-quality image can be obtained, the imager 122 will capture the image for matching against a database of visible spectrum face images. If the image lacks sufficient quality for matching, the system 110 can continue to track the person until an acceptable image can be gathered. Tracking software can be run on the processor 150 and allow the system 110 to follow a moving person over time. Up to 30 video frames per second can be captured, and the system 110 can automatically select the best facial images from the video to continually submit for face recognition. As more SWIR-illuminated facial images of the same person are collected and compared to a database of visible spectrum images, the scores and or ranks of the database images can be fused to produce an identification result that continues to increase in confidence level as the process continues. Just as a noisy signal can be clarified through time averaging, a face recognition capability that has low confidence for a single captured image can be made high confidence through capturing may images of the same person at slightly different times, angles, expressions, etc.

The apparatus 100 can use commercially-available face recognition software either off-the-shelf or as-modified for use with SWIR-illuminated images. An example is ABIS® System FaceExaminer software from MorphoTrust USA. A pre-processing filter can be applied to the SWIR-illuminated facial images to improve the matching performance of the SWIR-illuminated images to visible-spectrum images contained in the database. The system 110 operating system software allows the operator to submit video frames to the face recognition software by clicking a button on the GUI. Face recognition results can then be displayed in the apparatus 100 GUI. In an alternative embodiment, faces detected in the live video can be submitted automatically to the face recognition software.

Face recognition analysis can be performed by clicking a button on the GUI that sends up to 6 SWIR-illuminated video frames to the face recognition software for matching. Each of the 6 SWIR-illuminated images is matched against a visible spectrum face database, which is composed of standard visible face images. A score for each image is generated and the scores from the 6 submitted images are fused, and an aggregate result is displayed on the apparatus 100 GUI. To improve confidence level, the operator can send additional SWIR-illuminated images of the same individual, in groups of 6 at a time, to the face recognition software, with the new results fused with the old results. This process can be continued until a consistent, high-confidence match is obtained. At any point, the operator can manually adjust the marked eye positions to improve the accuracy of the results. The visible spectrum face image database can be updated and managed using a version of Morpho's Gallery Manager.

To automate the identification process, the apparatus 100 can automatically select video frames containing high-quality SWIR-illuminated facial images suitable for use by face recognition software. Once the target person to be identified distance and imager zoom level are within the limits of the face recognition capability, a face selection algorithm can be run that evaluates frames for facial image quality. For example, an algorithm can be used to detect eyes and a nose. The eye and nose detection positions are used, together with the focus quality of the face, to determine if the image is suitable for face recognition. To be considered a frontal face, two eyes must be detected in the upper half of the face box, one on the left and one on the right side of center, with eye spacing falling within a range of typical values, and a nose must be detected below the eyes and horizontally centered between the eyes.

Once integrated into the apparatus 100, selected images will be ranked by quality and queued for submission to face recognition software. When the face recognition software is ready for a new submission, the best facial image in the queue will be submitted and processed for matching against the database of visible-spectrum facial images. As long as a single individual is being tracked, face shots can continue to be submitted to the face recognition software and the matching results accumulated, continually increasing the confidence level of any potential match.

The system 110 operating software may be modified for use in mobile applications, such as with the alternative embodiment of the apparatus 300, but the overall purposes and general functionality remains the same. Some of the modifications for mobile applications may include one or more of those discussed herein. Different functions may be run on different computers, and there may be significant architectural differences, including possible changes in operating systems used, e.g., Microsoft Windows Server 2008 v. any other OS. Preferred software functionality can include System Control, User Interface, Automation, Face Recognition Integration, and Interoperability.

The system control software preferably provides all of the low-level functionality required for proper hardware operation. This includes software that moves the lenses to the correct positions for the required imager zoom and focus and illuminator divergence angle, turns the illuminator on and off and sets the correct power, configures the focal plane array and adjusts its settings, interfaces to the pan-tilt unit, LRF, and GPS, and controls the cooler/heater for the optical enclosure. The system control software also captures the video, processes it, saves it, and transmits it to other software modules or systems if needed. This software requires very low communication latency with the hardware, and therefore preferably is run on a CPU with a wired connection to the hardware. Fortunately, the processing requirements are rather modest and can be met with a small, low-power CPU, such as a Gumstix. If continuous recording of high-fidelity video is required, then adequate storage media can be connected locally to the CPU. Depending on the level of modularity required, this CPU can be integrated into the optical head 120 or the electronics box 160.

The graphical user interface (GUI) preferably displays live video to the operator and provides the operator with the ability to control all aspects of the apparatus 100 functionality and settings. A video screen occupies the majority of the GUI window. Target location, distance, and heading can be displayed under the video. The operator can click on a video image to cause the pan-tilt to automatically move to center on the clicked location. Buttons along the right column of the window allow quick access to common functions, such as start/stop video recording, save still image, toggle day/night mode, turn AGC on/off, start a new face recognition session with 6 new video frames, add 6 new video frames to the current face recognition session, and split screen to display face recognition results. Controls on the right side of the GUI window can be used to control camera functionality, including zoom, focus distance, and pan/tilt. Additional controls can be made visible when needed, such as the exposure and illuminator controls. Face recognition results also can be displayed on the right side of the window, while the video and camera controls remain displayed on the left. A menu bar can be included at the top of the screen to give the operator access to all functions and configuration options.

The apparatus 100 GUI can be run locally for a manned mission, displaying high-fidelity video, and giving the operator real-time pan-tilt-zoom-focus control of the camera. It also can be run remotely for unmanned missions, in which case the level of video quality and responsiveness of camera controls will depend upon the bandwidth of the communications link between the apparatus and the remote client running the GUI. The GUI can also be used to replay previously recorded video.

The automation software can include features to reduce the cognitive load on operators and increase the capability to produce real-time target identification. Automation software can detect personnel in the scene, displaying bounding boxes around detected personnel. An operator can select a target to track or the apparatus can be programmed to choose a target to track. The apparatus can then track a person to be identified as he or she moves, using closed-loop pan-tilt control and automatically zooming in on the face if the person is within the effective range for recognition. To improve the tracking performance while reducing load on the CPU, a video processing board (SightLine SLA-2000) can be used for video stabilization, motion detection, and target tracking. Cascade algorithms can be used for upper-body detection with SWIR-illuminated imagery. The algorithms can be optimized and integrated into the automation software. Because closed-loop tracking software requires low-latency, the software can be run on a local CPU if autonomous tracking is required. Because much of the processing will be done by the SLA-2000 board, the CPU requirements for the automation software can be met with a Gumstix or other small embedded computer.

The face recognition process can be automated so that identification can occur without operator intervention. Face detection algorithms can be developed using the same cascade as the upper-body detection but with different training data. Faces can be automatically detected in apparatus 100 imagery of humans at less than 200 m. Once faces are detected, eye-detection will be performed within the detected face. Once two eyes are detected, the face will be checked for pose and focus quality, and qualifying images will be queued for submission to the face recognition software. When a target is being tracked, all faces detected from that individual will be known to correspond to the same individual. All face recognition results for that individual will be fused using methods based on score and rank. Maximum score fusion will keep the highest matching score for each database candidate, while rank-based fusion will assign points to the top 5 ranked candidates for each search, with higher rank receiving higher score. As more SWIR-illuminated images are searched and the results fused, the score of a true positive will separate from all other candidates. The ratio of the top fused score to the second rank fused score can be used to determine confidence level and to set a threshold for generating an alert.

Interoperability software will allow the system to accept input from and generate output to external systems. For example, the apparatus 100 can accept geographical cuing from other systems, such as an UGS system. If a target is detected at a particular location, the apparatus can be tasked to cue to that location to capture imagery and/or attempt identification. The apparatus can also publish the location and identity, if known, of any targets it is tracking, along with imagery, for use by external systems. Interoperability can be accomplished via XML messaging, such as cursor on target (COT), or any other preferred scheme.

While the primary goal of the apparatus 100 is to detect and identify people, the unique signatures produced in the SWIR-illuminated imagery can provide the user a valuable tool in accessing and averting threats. There are many signatures that differ from the visible and thermal infrared bands, and thus the imagery generated by the apparatus 100 of the present invention can provide valuable information in addition to SWIR-illuminated images for identification.

For example, at distances greater than 400 meters, the apparatus 100 imagery is not suitable for facial recognition. At this greater range, however, there is sufficient data for person detection, tracking, and manual object recognition, such as whether a target is holding a weapon and/or whether he or she has specific facial features, such as a beard, mustache, or glasses. While there is decreased resolution at greater distances, the SWIR-illuminated imagery provides considerable information for video surveillance purposes.

In another example, water has a unique characteristic in the SWIR band because its absorption coefficient is three orders of magnitude higher than in the visible band. A snow pile, for example, appears completely black in an SWIR-illuminated image. This may be useful in situations where objects or people are placed in white camouflage but left uncovered of snow, or in situations where a person in wet clothing stands out as dark against a bright background.

In another example, clothing fabrics have a somewhat unique signature in SWIR-illuminated images. Clothing color, well outside of the SWIR band, has no influence on SWIR-illuminated image intensity. Material fabrics do, however, and the intensity level of a cotton shirt is different than that of clothing of a synthetic blend, which may be in stark contrast to the vegetation background. An application of this characteristic is in detecting a person in camouflage. While thermal infrared has been proven to be a valuable tool for person detection, SWIR-illuminated images reveal more detailed features from the target. Even though a person in camouflage may be difficult to detect using visible imagery, the target is very distinctive when illuminated with SWIR. Another advantage of SWIR-illuminated images is a byproduct of using an active illumination source. The incident light causes a retro reflection from field optics such as a sniper's binoculars or rifle scope. The resulting reflection from a gun scope or small set of binoculars can be acquired at a range of 1,815 meters in total darkness. The reflection from a scope or binoculars saturates the pixels making them very distinguishable from the background.

### Examples

Visible and SWIR-illuminated facial imagery was collected from 56 subjects. An experiment was performed using a commercial face recognition software package, ABIS® System FaceExaminer from Identix (now MorphoTrust USA), in which a single SWIR-illuminated facial image from each subject was matched against a database containing 1156 visible-spectrum facial images, including 1 visible image from each of the 56 subjects and 1100 visible images from the FERET facial database. The commercial software, which had been designed only to match visible-spectrum images to other visible-spectrum images, achieved a correct match for 40 out of 56 subjects, for a Rank 1 success rate of 71%.

Later, two datasets of SWIR-illuminated facial imagery were collected using the methods and apparatus of the present invention. The first dataset collected included facial imagery of 56 subjects at distances of 50 m and 106 m, indoors in total darkness. For each subject, frontal still images were collected with both neutral and talking expressions, and images were collected with the head turned left and right by 10° and 20° while talking. The second dataset included facial video imagery of 104 subjects at distances of 100 m, 200 m, and 350 m, all collected outdoors under dark nighttime conditions. Video was collected with the subjects stationary and facing the camera as well as with the subjects rotating 360°. As expected, the resolution and contrast degrade as the distance increases, but sufficient resolution remains at 350 m for possible recognition.

A pre-processing algorithm was applied to the SWIR-illuminated images before matching them to a visible-spectrum database using FaceIt G8 software from MorphoTrust USA. A Rank 1 success rate of 90% was achieved for the 50 m SWIR-illuminated images and 80% for the 106 m SWIR-illuminated images. The results of the FaceIt G8 software were fused with a face recognition algorithm. With a 0.1% False Acceptance Rate, a Correct Acceptance Rate of 85% was achieved for the 50 m SWIR-illuminated images and 74% for the 106 m SWIR-illuminated images.

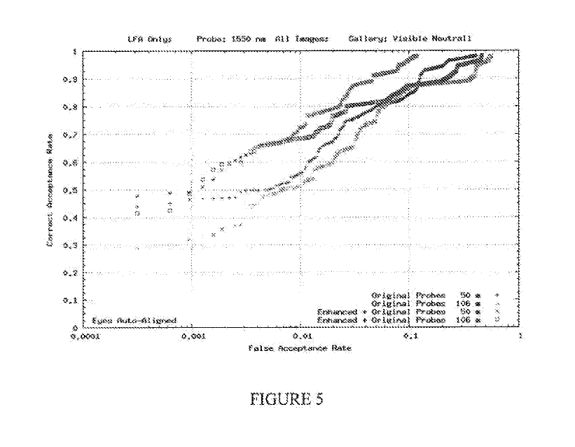

To evaluate the pre-processing filter, 9 SWIR-illuminated images were processed for each subject at each distance, including 3 frontal neutral images, 2 frontal talking images, and 4 images with a 10° pose angle. Each image was pre-processed and matched against a database containing visible-spectrum images of all 56 subjects. For each subject, the results of the 9 searches were fused by keeping the result with the highest matching score. FIG. 5 shows the receiver operating characteristics (ROC) results at 50 m and 106 m with and without the pre-processing algorithm. With a 1% False Acceptance Rate, the pre-processed results achieved a Correct Acceptance Rate of roughly 70% at both 50 m and 106 m. Surprisingly, the images with 10° pose angle accounted for more than 25% of the highest scores in the successful matches, indicating the algorithm is fairly robust for pose angles within 10° of frontal.

### CONCLUSION

While various embodiments of the present invention have been described above, it should be understood that they have been presented by way of example only, and not limitation. It will be understood by those skilled in the art that various changes in form and details may be made therein without departing from the spirit and scope of the invention. Thus, the breadth and scope of the invention should not be limited by any of the above-described exemplary embodiments.

What is claimed is:

1. An active-imaging system, comprising:
an optical head comprising (i) a short-wave infrared (SWIR) imager having a field of view and (ii) an illuminator, wherein the imager and illuminator are aligned and mounted on a single pan-tilt stage such that the illuminator produces a beam of light always centered on the imager field of view, and further wherein the illuminator uses a wavelength of light greater than 1400 nm and less than 1700 nm;
an electronics box comprising power supplies, communications electronics, and a light source for the illuminator, wherein the electronics box is connected to the optical head by an umbilical comprising cables to deliver light and power to support data communication to and from the optical head; and
a processor connected to the electronics box for comparing facial images captured by the imager to a database of visible-spectrum face images.

2. The active-imaging system of claim 1, further comprising a laser range finder for measuring distances to objects or people to be illuminated and imaged.

3. The active-imaging system of claim 1, wherein the pan-tilt stage can be controlled to automatically keep the imager field of view centered on a moving person or object.

4. The active-imaging system of claim 1, wherein the illuminator uses a wavelength of light between 1500 nm and 1600 nm.

5. The active-imaging system of claim 1, wherein the illuminator creates a beam produced by an LED, and further wherein the beam is filtered by a bandpass filter and is amplified by an optical amplifier.

6. The active-imaging system of claim 1, wherein the illuminator and imager are synchronized such that the illuminator beam divergence automatically adjusts as the imager zooms to match the illumination spot size to the imager field of view.

7. An apparatus, comprising:
an active-imaging system for capturing facial images illuminated with short-wave infrared light having a wavelength greater than 1400 nm and less than 1700 nm;
a processor in communication with said active-imaging system, wherein the processor compares facial images captured by the active-imaging system to a database of visible-spectrum face images to locate a match and identify a person.

8. The active-imaging system of claim 7, further comprising a laser range finder for measuring distances to objects or people to be illuminated and imaged.

9. The apparatus of claim 7, wherein the active-imaging system comprises an optical head having (i) a short-wave infrared (SWIR) imager with a field of view, and (ii) an illuminator; wherein the illuminator uses a wavelength of between 1500 nm and 1600 nm.

10. The apparatus of claim 9, wherein the imager and illuminator are aligned and mounted on a single pan-tilt stage such that the illuminator produces a beam of light always centered on the imager field of view.

11. The apparatus of claim 9, further comprising an electronics box including power supplies, communications electronics, and a light source for the illuminator; wherein the electronics box is connected to the optical head by an umbilical with cables to deliver light and power to support data communication to and from the optical head.

12. The apparatus of claim 10, wherein the pan-tilt stage can be controlled to automatically keep the imager field of view centered on a moving person or object.

13. The active imaging system of claim 9, wherein video frames containing facial imagery are automatically detected, captured, and submitted to the processor to be compared to a database of visible-spectrum face images to locate a match and identify a person.

14. The active-imaging system of claim 9, wherein the illuminator creates a beam produced by an LED, and further wherein the beam is filtered by a bandpass filter and is amplified by an optical amplifier.

15. The active-imaging system of claim 9, wherein the illuminator and imager are synchronized such that the illuminator beam divergence automatically adjusts as the imager zooms to match the illumination spot size to the imager field of view.

16. A method of identifying a person using biometric facial recognition, comprising:
illuminating the person's face with SWIR, wherein the SWIR is between 1400 nm and 1700 nm;
capturing an image of the person's face while illuminated with SWIR; and
comparing the captured facial image to a database of visible-spectrum facial images to locate a match and identify a person.

17. The method of claim 16, wherein the person's face is illuminated and the image captured using an active-imaging system, comprising an optical head comprising (i) a short-wave infrared (SWIR) imager having a field of view, and (ii) an illuminator; wherein the imager and illuminator are aligned and mounted on a single pan-tilt stage such that the illuminator produces a beam of light always centered on the imager field of view.

18. The method of claim 17, wherein the active-imaging system further comprises an electronics box comprising power supplies, communications electronics, and a light source for the illuminator, wherein the electronics box is connected to the optical head by an umbilical comprising cables to deliver light and power to support data communication to and from the optical head.

19. The method of 18, further comprising a processor connected to the electronics box for comparing facial images captured by the imager to a database of visible-spectrum face images.

20. The method of claim 16, wherein the SWIR is between 1500 nm and 1600 nm.

21. A method of identifying a person using biometric facial recognition, comprising:
detecting the presence of the person to be identified;
illuminating the person's face with short-wave infrared (SWIR) light having a wavelength greater than 1400 nm and less than 1700 nm;
capturing an image of the person's face while illuminated with the SWIR light; and
matching the captured image to a database of visible spectrum images.

22. The method of claim 21, further comprising tracking the person to be identified to capture an image of the person's face.

23. The method of claim 21, further comprising repetitively submitting captured images for facial recognition, and fusing recognition results to increase the confidence level of the match.
